(19) United States
(12) Patent Application Publication
(10) Pub. No.: US 2022/0083358 A1
(43) Pub. Date: Mar. 17, 2022

(54) SIMULATION APPARATUS AND METHOD OF CONTROLLING THE SAME

(71) Applicants: HYUNDAI MOTOR COMPANY, Seoul (KR); KIA CORPORATION, Seoul (KR)

(72) Inventor: Seung Yong Kwak, Anyang-si (KR)

(21) Appl. No.: 17/410,308

(22) Filed: Aug. 24, 2021

(30) Foreign Application Priority Data
Sep. 14, 2020 (KR) 10-2020-0117569

(51) Int. Cl. G06F 9/455; G06F 9/48

(52) U.S. Cl. CPC G06F 9/455; G06F 9/485

(57) ABSTRACT

A simulation apparatus includes: an Input Output (I/O) interface configured to obtain an Application Software (ASW) and a Runtime Environment (RTE); a storage configured to store a Basic Software (BSW) including a virtual operating system, a virtual memory, a virtual communication interface, a virtual input/output interface, and a plurality of virtual hardware drivers; and a processor configured to simulate the application software using the basic software.

### CROSS-REFERENCE TO RELATED APPLICATION(S)

This application is based on and claims the benefit of priority to Korean Patent Application No. 10-2020-0117569, filed on Sep. 14, 2020 in the Korean Intellectual Property Office, the disclosure of which is incorporated herein by reference.

### TECHNICAL FIELD

The present disclosure relates to a simulation apparatus and a method of controlling the same, and more particularly, to a simulation apparatus capable of simulating an electric device installed in a vehicle and a method of controlling the same.

### BACKGROUND

A vehicle is a moving means or transportation means for driving on a road and railway using fossil fuels and/or electricity as a power source.

Such a vehicle is more than simply transporting goods and personnel, but provides fun and convenience to a driver with various electric devices (e.g., air conditioners, media players, seat heating wires, seat ventilation devices, etc.) installed therein. In addition, a vehicle may include various controllers for controlling various electric devices.

A vehicle controller such as an electronic control unit (ECU) performs an important function of controlling an operation of the vehicle, and an error in hardware or software of the controller may cause an accident in the vehicle. In order to prevent accidents due to errors of the controller, the controller is simulated in various ways by means of a simulation apparatus.

However, in the past, the controller software was simulated by virtualizing the input/output of the controller software.

The information included in this Background section is only for enhancement of understanding of the general background of the present disclosure and may not be taken as an acknowledgement or any form of suggestion that this information forms the prior art already known to a person skilled in the art.

### SUMMARY

An aspect of the disclosure is to provide a simulation apparatus capable of virtualizing an operating system (OS) and a hardware as well as input and output when simulating a software of a controller, and a method of controlling the simulation apparatus.

Additional aspects of the disclosure will be set forth in part in the description which follows and, in part, will be obvious from the description, or may be learned by practice of the disclosure.

According to an aspect of the disclosure, there is provided a simulation apparatus including: an input/output interface configured to obtain an application software (ASW) and a runtime environment (RTE); a storage configured to store a basic software (BSW) including a virtual operating system, a virtual memory, a virtual communication interface, a virtual input/output interface, and a plurality of virtual hardware drivers; and a processor configured to simulate the application software using the basic software. The processor may be configured to select at least one virtual hardware driver among the plurality of virtual hardware drivers depending on a controller on which the application software is installed, and to simulate the application software using the virtual operating system, the virtual memory, the virtual communication interface, the virtual input/output interface, and the at least one virtual hardware driver.

The plurality of virtual hardware drivers may include a plurality of microcontroller abstraction layers (MCALs) and a plurality of complex device drivers (CDDs).

The processor may be configured to generate a plurality of threads corresponding to a plurality of tasks processed by the application software before the application software is simulated.

The processor may be configured to execute a first thread among the plurality of threads, and to stop the execution of the first thread and execute a second thread among the plurality of threads in response to an event occurrence.

The processor may be configured to obtain an output of the application software based on the simulation of the application software, and to provide image data for visualizing an operation of a virtual vehicle in which the application software is installed based on the output of the application software.

The processor may be configured to obtain an intermediate output value by the application software during the simulation, and to provide image data for visualizing the intermediate output value.

The processor may be configured to obtain data of the virtual memory, the virtual communication interface, and the virtual input/output interface by the application software during the simulation, and to provide image data to visualize the data.

The simulation apparatus may further include a display configured to visualize the operation of the virtual vehicle based on the image data.

According to another aspect of the disclosure, there is provided a method of controlling a simulation apparatus including: obtaining an application software (ASW) and a runtime environment (RTE) through an input/output interface; obtaining a basic software (BSW) including a virtual operating system, a virtual memory, a virtual communication interface, a virtual input/output interface, and a plurality of virtual hardware drivers from a storage; and simulating, by a processor, the application software using the basic software.

The simulating of the application software may include selecting at least one virtual hardware driver among the plurality of virtual hardware drivers depending on a controller on which the application software is installed; and simulating the application software using the virtual operating system, the virtual memory, the virtual communication interface, the virtual input/output interface, and the at least one virtual hardware driver.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a view illustrating a configuration of a simulation apparatus according to an embodiment of the present disclosure.

FIG. 2 is a view illustrating a software input to a simulation apparatus, a virtual operating system, and a virtualized hardware according to an embodiment of the present disclosure.

FIG. 3 is a view illustrating a virtualization of a hardware in a simulation apparatus according to an embodiment of the present disclosure.

FIGS. 4A and 4B are views illustrating processing of a thread in a simulation apparatus according to an embodiment of the present disclosure.

### DETAILED DESCRIPTION

Hereinafter, an operation principle and embodiments of the disclosure will be described with reference to accompanying drawings.

Reference will now be made in detail to various embodiments of the present disclosure, examples of which are illustrated in the accompanying drawings and described below. While the present disclosure will be described in conjunction with exemplary embodiments of the present disclosure, it will be understood that the present description is not intended to limit the present disclosure to those exemplary embodiments. On the other hand, the present disclosure is intended to cover not only the exemplary embodiments of the present disclosure, but also various alternatives, modifications, equivalents and other embodiments, which may be included within the spirit and scope of the present disclosure as defined by the appended claims.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

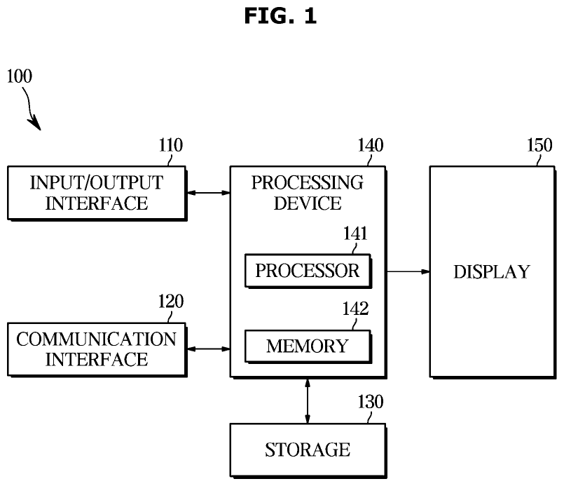

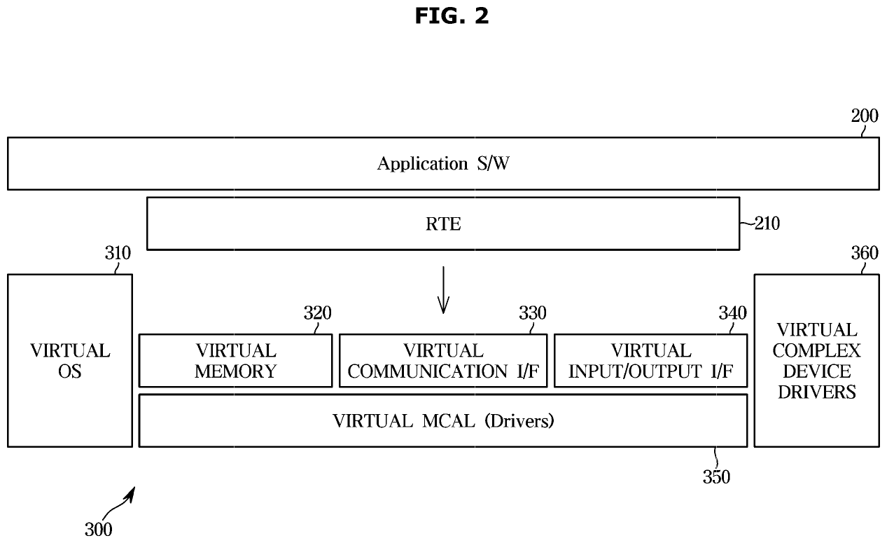

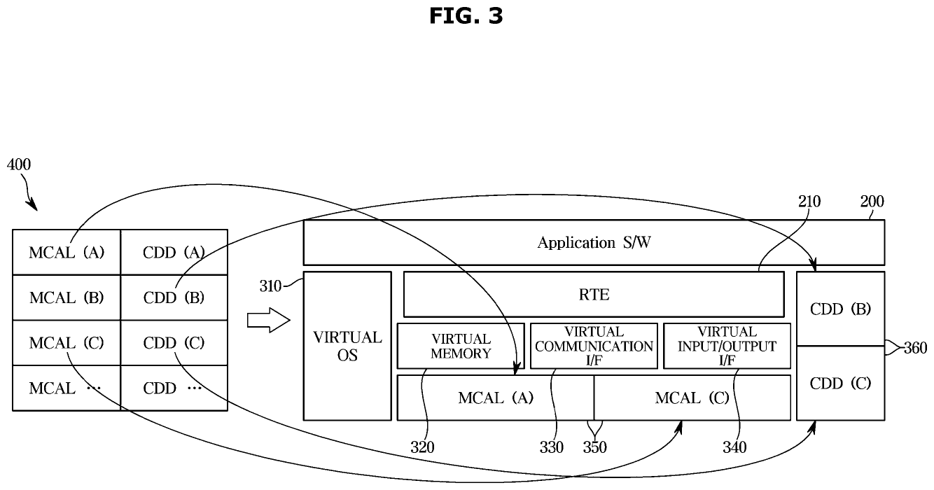

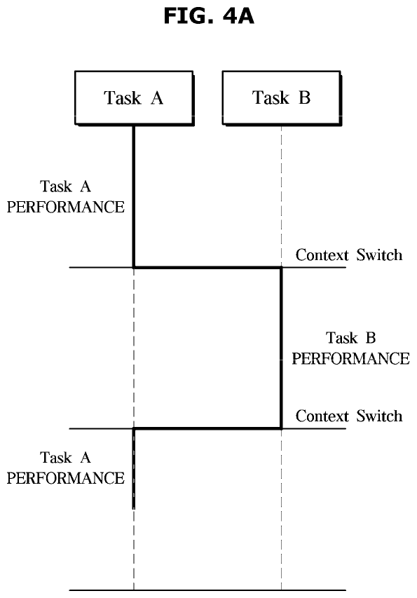

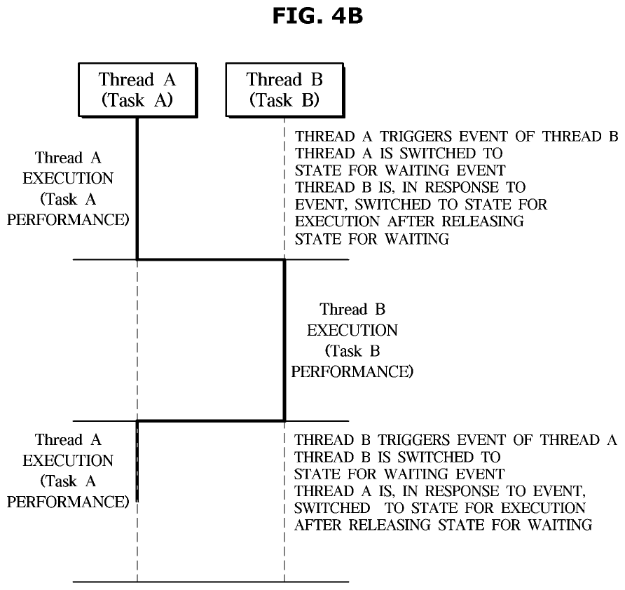

FIG. 1 is a view illustrating a configuration of a simulation apparatus according to an embodiment of the present disclosure. FIG. 2 is a view illustrating a software input to a simulation apparatus, a virtual operating system, and a virtualized hardware according to an embodiment of the present disclosure. FIG. 3 is a view illustrating a virtualization of a hardware in a simulation apparatus according to an embodiment of the present disclosure. FIGS. 4A and 4B are views illustrating processing of a thread in a simulation apparatus according to an embodiment of the present disclosure.

Referring to FIGS. 1, 2, 3, 4A and 4B, a simulation apparatus 100 may include an input/output interface 110 for obtaining an application software 200, a communication interface 120 for receiving the application software 200, a storage 130 that stores programs and data for simulating the application software 200, a processing device 140 for simulating the application software 200, and a display 150 for displaying a simulation result by the processing device 140.

The input/output interface 110 may obtain the application software (ASW) 200 and a runtime environment (RTE) 210 to be simulated.

Here, the application software 200 may be a series of commands for controlling a controller to be installed in a vehicle. In other words, when the application software 200 is installed in a vehicle controller, the controller may perform a task defined by an application.

In addition, the runtime environment 210 may refer to an environment in which the application software 200 is executed, and may implement a part of the application software 200. The runtime environment 210 may include a method for the application software 200 to access variables, a mechanism for passing parameters between procedures, a method for communicating with an operating system, and the like.

The input/output interface 110 may be an input device that receives the application software 200 and the runtime environment 210 from a user (a designer of the vehicle controller or a simulated tester of the vehicle controller). For example, the input/output interface 110 may include a character input device (e.g., a keyboard), a point input device (e.g., a mouse, a trackball, etc.), or the like.

The input/output interface 110 may be an interface device for loading the application software 200 and the runtime environment 210 from a portable storage medium. For example, the input/output interface 110 may include a Universal Serial Bus (USB) interface, a display output interface (e.g., a High Definition Multimedia Interface (HDMI) interface, a Digital Visual Interface (DVI) interface, an RGB interface), and the like.

The input/output interface 110 may obtain the application software 200 and the runtime environment 210 and provide the obtained application software 200 and the runtime environment 210 to the processing device 140.

The communication interface 120 may communicate with an external device and may receive the application software 200 and the runtime environment 210 from the external device.

The communication interface 120 may receive the application software 200 and the runtime environment 210 from the external device in a wired communication method (e.g., Ethernet, etc.) for wired communication.

In addition, the communication interface 120 may receive the application software 200 and the runtime environment 210 from the external device in a wireless communication method (e.g., Wi-Fi, Bluetooth, ZigBee, etc.) for wireless communication.

The communication interface 120 may provide the application software 200 and the runtime environment 210 received from the external device to the processing device 140.

The storage 130 may store programs and data for simulating the application software 200.

For example, the storage 130 may store basic software (BSW) 300 as data for simulating the application software 200 as illustrated in FIG. 2. The basic software 300 may include a virtual operating system 310, a virtual memory 320, a virtual communication interface 330, a virtual input/output interface 340, and virtual hardware drivers 350 and 360. In addition, the storage 130 may store programs for simulating the application software 200 on the virtualized configurations 310, 320, 330, 340, 350, and 360.

The virtual operating system 310 may manage hardware resources (e.g., virtual memory, virtual communication interface, virtual input/output interface, etc.) of a microcontroller constituting the vehicle controller and software resources such as application software 200.

The virtual memory 320 may store or memorize the application software 200 and simulate storing or memorizing temporary data generated by an operation of the application software 200.

The virtual communication interface 330 may simulate transmitting and receiving data with other electric devices in the vehicle through a vehicle communication network.

The virtual input/output interface 340 may simulate receiving data from the microcontroller constituting the vehicle controller and outputting data from the microcontroller.

The virtual hardware drivers 350 and 360 may include a microcontroller abstraction layer (MCAL) 350 and a complex device driver (CDD) 360.

Here, the microcontroller abstraction layer may be composed of drivers for using internal devices of a microcontroller. For example, the microcontroller abstraction layer may include microcontroller drivers such as GPT and Watchdog, memory drivers such as electrically erasable programmable ROM (EEPROM) and Flash, communication drivers such as Controller Area Network (CAN) and Local Interconnect Network (LIN), and analog digital I/O drivers such as ADC and PWM. The microcontroller abstraction layer may serve to enable independent development of an upper software layer and hardware.

In addition, the complex device driver may include drivers for functions not defined in the AUTOSAR standard.

The storage 130 may store the plurality of virtual hardware drivers 350 and 360 corresponding to various types of hardware.

As illustrated in FIG. 3, the storage 130 may store a pool 400 including the plurality of microcontroller abstraction layers 350 corresponding to a plurality of microcontrollers. In addition, the storage 130 may provide at least one microcontroller abstraction layer 350 among the plurality of microcontroller abstraction layers 350 included in the pool 400 to the processing device 140 in response to a request of the processing device 140.

In addition, the pool 400 of the storage 130 may include the plurality of complex device drivers 360 for a plurality of functions. The storage 130 may provide at least one complex device driver 360 among the plurality of complex device drivers 360 included in the pool 400 to the processing device 140 in response to the request of the processing device 140.

The storage 130 may include a non-volatile memory in which stored data is stored even when the simulation apparatus 100 is turned off. For example, the storage 130 may include a hard disk drive (HDD) or a Solid State Drive (SSD).

The storage 130 may provide the stored data to the processing device 140 in response to the request of the processing device 140.

The processing device 140 may obtain the application software 200 and the runtime environment 210 through the input/output interface 110 and/or the communication interface 120.

The processing device 140 may obtain the basic software 300 for simulating the application software 200 from the storage 130. For example, the processing device 140 may obtain the virtual operating system 310, the virtual memory 320, the virtual communication interface 330, the virtual input/output interface 340, and the virtual hardware drivers 350 and 360 from the storage 130.

The processing device 140 may obtain information related to the controller on which the application software 200 operates. Based on the information related to the controller, the processing device 140 may obtain the virtual operating system 310, the virtual memory 320, the virtual communication interface 330, the virtual input/output interface 340, and the virtual hardware drivers 350 and 360 from the storage 130.

In particular, the processing device 140 may extract at least one of the plurality of microcontroller abstraction layers 350 stored in the storage 130 and extract at least one of the plurality of complex device drivers 360. For example, as illustrated in FIG. 3, the processing device 140 may select MCAL (A) and MCAL (C) among MCAL (A), MCAL (B), MCAL (C), . . . , and may select CDD (B) and CDD (C) among CCD(A), CDD (B), CDD (C), . . . .

The processing device 140 may simulate the application software 200 by executing the application software 200 and the basic software 300 using the obtained program and data.

For example, the processing device 140 may combine the virtual operating system 310, the virtual memory 320, the virtual communication interface 330, the virtual input/output interface 340, and the virtual hardware drivers 350 and 360 to the application software 200 and the runtime environment 210, and may simulate the application software 200.

The processing device 140 may cause the application software 200 to use a plurality of threads in order to simulate that the vehicle controller performs various tasks.

In addition, the processing device 140 may simulate that the vehicle controller alternately performs various tasks, generate all of the plurality of threads when starting the simulation of the application software 200, and control transitions between the threads through event processing.

For example, as illustrated in FIG. 4A, the microcontroller of an actual controller may alternately process the various tasks. The microcontroller may process task A. Due to the occurrence of an event while processing the task A, the microcontroller may stop processing task A and process task B. Further, due to the occurrence of the event (e.g., completion of task B processing) while processing task B, the microcontroller may stop processing of task B and process task A.

As illustrated in FIG. 4B, the processing device 140 may alternately execute various threads so that the application software 200 may alternately process the various tasks by simulating the processing of the microcontroller of the actual controller.

The processing device 140 may generate the plurality of threads each corresponding to a plurality of tasks that can be processed by the application software 200. In other words, the processing device 140 may generate the plurality of threads before starting the simulation of the application software 200.

The processing device 140 may execute thread A so that the application software 200 processes the task A. The processing device 140 may stop the execution of thread A and execute thread B so that the application software 200 stops processing of the task A and processes the task B due to the occurrence of the event while executing the thread A. In addition, processing device 140 may stop execution of thread B and execute thread A so that the application software 200 stops processing of the task B and processes the task A due to the occurrence of the event while executing the thread B.

In this way, the processing device 140 may input a simulated input to the application software 200 for the simulation, and obtain a simulated output of the application software 200 in response to the simulated input.

For example, in a case of the application software 200 for power steering, the processing device 140 may input a steering angle and a steering torque to the application software 200 and obtain an output of the application software 200 for steering control. In addition, in a case of the application software 200 for a brake system, the processing device 140 may input a wheel slip to the application software 200 and obtain an output of the application software 200 for an anti-lock brake system (ABS) operation.

In addition, the processing device 140 may apply the simulated output of the application software 200 to the operation of a virtual vehicle. Thereby, the operation of the virtual vehicle by the operation of the application software 200 may be visualized.

The processing device 140 may obtain an intermediate output value and/or an electrical signal by the application software 200 during the simulation, and may output image data for visually indicating the operation of the application software 200. For example, the processing device 140 may output the image data for visually indicating an operation of a timer that is actually executed during the simulation of the application software 200. The processing device 140 may output image data for visually indicating a processing order and/or a processing priority of the application software 200 for a plurality of inputs during the simulation of the application software 200. The processing device 140 may output image data for visually indicating data stored in the virtual memory 320 during the simulation of the application software 200. The processing device 140 may output image data for visually indicating data received through the virtual communication interface 330 during the simulation of the application software 200.

The processing device 140 may include a processor 141 that processes the simulation of the application software 200 and a memory 142 that stores program and data for the simulation of the application software 200. The processing device 140 may include, for example, one or more processors or one or more memories. Each of the processor 141 and the memory 142 may be implemented as a separate semiconductor element, or may be implemented as a single semiconductor element.

The memory 142 may include a volatile memory device, such as static random access memory (S-RAM) and dynamic random access memory (D-RAM), a non-volatile memory device, such as read only memory (ROM) and erasable programmable read only memory (EPROM). The memory 142 may include one memory element or may include a plurality of memory elements.

The processor 141 may include an operation circuit, a memory circuit, and a control circuit. The processor 141 may include one chip or may include a plurality of chips. The processor 141 may include one core or may include a plurality of cores.

The display 150 may receive the image data for visualizing the operation of the virtual vehicle by the operation of the application software 200 from the processing device 140, and visualize the operation of the virtual vehicle by the operation of the application software 200.

For example, in the case of the application software 200 for power steering, the display 150 may visualize a steering control of the virtual vehicle by the output of the application software 200. In addition, in the case of the application software 200 for the brake system, the display 150 may visualize an ABS control of the virtual vehicle by the output of the application software 200.

As described above, the simulation apparatus 100 may store the virtual operating system, the virtual hardware driver, and the like, and may simulate the application software 200.

According to the embodiments of the disclosure, when simulating the software of the controller, it is possible to virtualize not only the input and output but also the operating system (OS) and the hardware.

An aspect of the disclosure is to provide a vehicle capable of virtualizing an operating system (OS) and a hardware as well as input and output when simulating a software of a controller, and a method of controlling the vehicle.

Furthermore, the term related to a control device such as “controller”, “control unit”, “control device” or “control module”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may generate a control signal according to the processing result.

The control device may be at least one microprocessor operated by a predetermined program which may include a series of commands for carrying out the method included in the aforementioned various exemplary embodiments of the present disclosure.

The aforementioned disclosure can also be embodied as computer readable codes on a computer readable recording medium. The computer readable recording medium is any data storage device that can store data which may be thereafter read by a computer system. Examples of the computer readable recording medium include hard disk drive (HDD), solid state disk (SSD), silicon disk drive (SDD), read-only memory (ROM), random-access memory (RAM), CD-ROMs, magnetic tapes, floppy discs, optical data storage devices, etc. and implementation as carrier waves (e.g., transmission over the Internet).

In various exemplary embodiments of the present disclosure, each operation described above may be performed by a control device, and the control device may be configured by a plurality of control devices, or an integrated single control device.

In various exemplary embodiments of the present disclosure, the control device may be implemented in a form of hardware or software, or may be implemented in a combination of hardware and software.

Embodiments of the disclosure have thus far been described with reference to the accompanying drawings. It should be apparent to those of ordinary skill in the art that the disclosure may be practiced in other forms than the embodiments as described above without changing the technical idea or essential features of the disclosure. The above embodiments are only by way of example, and should not be interpreted in a limited sense.

What is claimed is:

1. A simulation apparatus comprising:
an input output (I/O) interface configured to obtain an Application Software (ASW) and a Runtime Environment (RTE);
a storage configured to store a Basic Software (BSW), wherein the basic software includes a virtual operating system, a virtual memory, a virtual communication interface, a virtual I/O interface, and a plurality of virtual hardware drivers; and
a processor configured to:
simulate the application software using the basic software,
select at least one virtual hardware driver among the plurality of virtual hardware drivers depending on a controller on which the application software is installed, and
simulate the application software using the virtual operating system, the virtual memory, the virtual communication interface, the virtual input/output interface, and the at least one virtual hardware driver.

2. The simulation apparatus according to claim 1, wherein the plurality of virtual hardware drivers comprise a plurality of Microcontroller Abstraction Layers (MCALs) and a plurality of Complex Device Drivers (CDDs).

3. The simulation apparatus according to claim 1, wherein the processor is configured to generate a plurality of threads corresponding to a plurality of tasks processed by the application software before the application software is simulated.

4. The simulation apparatus according to claim 3, wherein the processor is configured to:
execute a first thread among the plurality of threads, and
in response to an event occurrence, stop the execution of the first thread and execute a second thread among the plurality of threads.

5. The simulation apparatus according to claim 1, wherein the processor is configured to:
based on the simulation of the application software, obtain an output of the application software, and
based on the output of the application software, provide image data for visualizing an operation of a virtual vehicle in which the application software is installed.

6. The simulation apparatus according to claim 1, wherein the processor is configured to:
obtain an intermediate output value by the application software during the simulation, and
provide image data for visualizing the intermediate output value.

7. The simulation apparatus according to claim 1, wherein the processor is configured to:
obtain data of the virtual memory, the virtual communication interface, and the virtual I/O interface by the application software during the simulation, and
provide image data to visualize the data.

8. The simulation apparatus according to claim 5, further comprising a display configured to visualize the operation of the virtual vehicle based on the image data.

9. A method of controlling a simulation apparatus comprising:
obtaining an Application Software (ASW) and a Runtime Environment (RTE) through an Input Output (I/O) interface;
obtaining a Basic Software (BSW), where the base software includes a virtual operating system, a virtual memory, a virtual communication interface, a virtual I/O interface, and a plurality of virtual hardware drivers from a storage; and
simulating, by a processor, the application software using the basic software,
wherein the simulating of the application software comprises:
selecting at least one virtual hardware driver among the plurality of virtual hardware drivers depending on a controller on which the application software is installed, and
simulating the application software using the virtual operating system, the virtual memory, the virtual communication interface, the virtual I/O interface, and the at least one virtual hardware driver.

10. The method according to claim 9, wherein the plurality of virtual hardware drivers comprise a plurality of Microcontroller Abstraction Layers (MCALs) and a plurality of Complex Device Drivers (CDDs).

11. The method according to claim 9, wherein the simulating of the application software comprises generating a plurality of threads corresponding to a plurality of tasks processed by the application software before the application software is simulated.

12. The method according to claim 11, wherein the simulating of the application software comprises:
executing a first thread among the plurality of threads; and
in response to an event occurrence, stopping the execution of the first thread and executing a second thread among the plurality of threads.

13. The method according to claim 9, wherein the simulating of the application software comprises:
based on the simulation of the application software, obtaining an output of the application software; and
based on the output of the application software, providing image data for visualizing an operation of a virtual vehicle in which the application software is installed.

14. The method according to claim 9, wherein the simulating of the application software comprises:
obtaining an intermediate output value by the application software during the simulation; and
providing image data for visualizing the intermediate output value.

15. The method according to claim 9, wherein the simulating of the application software comprises:
obtaining data of the virtual memory, the virtual communication interface, and the virtual I/O interface by the application software during the simulation; and
providing image data to visualize the data.

16. The method according to claim 13, further comprising visualizing, by a display, the operation of the virtual vehicle based on the image data.
